(19) United States
(12) Patent Application Publication
(10) Pub. No.: US 2006/0115280 A1
(43) Pub. Date: Jun. 1, 2006

(54) Optical link bandwidth improvement

(76) Inventors: Jae Joon Chang, San Jose, CA (US); Stefano Therisod, Sunnyvale, CA (US); Myunghee Lee, San Jose, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/000,108

(22) Filed: Nov. 30, 2004

(51) Int. Cl. H04B 10/06

(52) U.S. Cl. 398/208

(57) ABSTRACT

An optical receiver system includes an amplifier circuit and a compensation circuit. The amplifier circuit includes a light detector, and a transimpedance amplifier. The transimpedance amplifier produces an amplified signal. The compensation circuit includes at least one pole compensation stage that performs pole compensation on the amplified signal.

### BACKGROUND

In optical systems where data is transmitted through optical fibers, a demand for higher data transfer rate requires that optical receiver systems be designed with a wide bandwidth. In order to increase bandwidth in an optical receiver system, efforts have been made to increase the bandwidth of a transimpedance amplifier (TIA) within the optical receiver system. The bandwidth of the TIA is increased, for example, by use of more expensive, high performance process technology, by reducing the input resistance to the TIA and/or by employing new architectures, such as common base architecture, for the implementation of TIA in order to avoid the Miller effect. Bandwidth of the optical receiver system can also be increased by reducing parasitic capacitance in a photo-detector that is used to convert light signals to electrical signals.

Each of the above-discussed ways used to increase bandwidth in an optical receiver system has disadvantages and/or tradeoffs. For example, using more expensive, high performance technology to implement the TIA can significantly increase the cost of the optical receiver system. Reducing the input resistance to the TIA requires use of a bigger transistor size resulting in increased power consumption. Use of architectures, such as common base amplifier architecture, to avoid the Miller effect results in noise degradation in the TIA. Reducing parasitic capacitance in the photo-detector requires a decreased photo-detector size resulting in alignment issues and other bonding issues.

Additionally, as data transfer rate increases, additional issues arise which can result in degradation of reception quality. For example, the intrinsic non-linear characteristics of light-emitting devices used to transmit signals through the optical fiber can result in eye quality degradation of the established optical link. The intrinsic non-linear characteristics include relaxation oscillation or slow tail of falling signal. Such behaviors of light-emitting device characteristics are not simple to compensate for in the optical receiver system. Traditionally, low pass filtering techniques are used to filter out the relaxation oscillation frequency component of light emitting diodes. However, such low pass filtering techniques conflict with efforts to increase bandwidth in receiver systems. Designers have also tried to design light-emitting devices so as to speed up the falling edge of optical signal to reduce the effect of slow tail. However, designing light-emitting devices with these two contradicting design constraints requires a lot of effort, increases development time and provides diminishing returns in signal quality.

### SUMMARY OF THE INVENTION

In accordance with an embodiment of the present invention, an optical receiver system includes an amplifier circuit and a compensation circuit. The amplifier circuit includes a light detector, and a transimpedance amplifier. The transimpedance amplifier produces an amplified signal. The compensation circuit includes at least one pole compensation stage that performs pole compensation on the amplified signal.

### BRIEF DESCRIPTION OF THE DRAWINGS

FIG. 1 is a simplified block diagram of an optical transmission system.

FIG. 2 is a simplified block diagram of an optical receiver system that includes a compensation circuit in accordance with an embodiment of the present invention.

FIG. 3 is a simplified block diagram of an optical receiver system that includes another compensation circuit in accordance with another embodiment of the present invention.

FIG. 4 is a diagram illustrating operation of a compensation stage in accordance with an embodiment of the present invention.

FIG. 5 shows an example of a single pole compensation stage used in a compensation circuit within an optical receiver system in accordance with another embodiment of the present invention.

FIG. 6 shows another example of a single pole compensation stage used in a compensation circuit within an optical receiver system in accordance with another embodiment of the present invention.

### DESCRIPTION OF THE EMBODIMENT

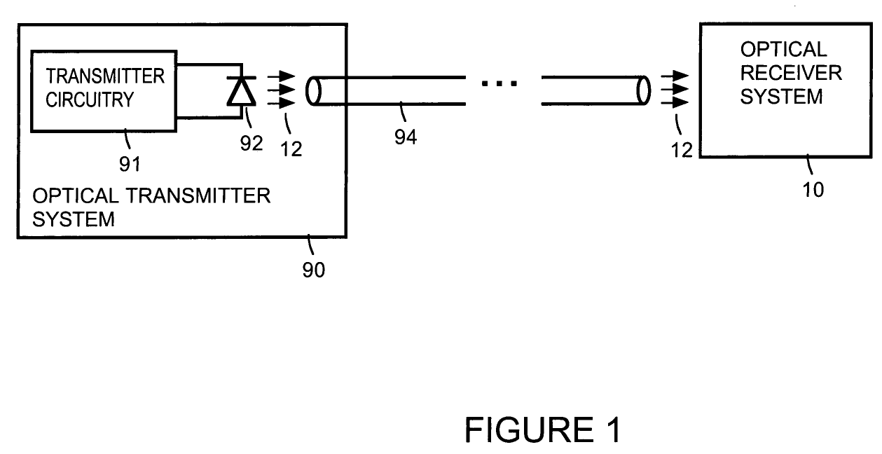

FIG. 1 is a simplified block diagram of an optical transmission system. An optical transmitter system 90 includes transmitter circuitry 91 and a light-emitting device 92. Light emitting device 92 generates light signals 12 which are transmitted through an optical cable 94 to an optical receiver system 10.

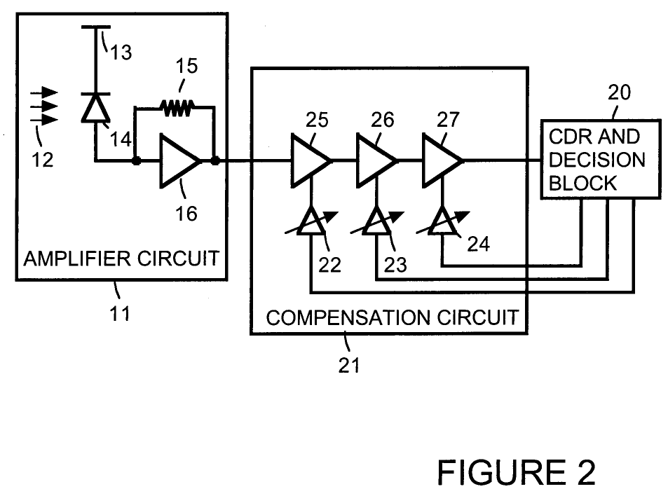

FIG. 2 is a simplified block diagram of optical receiver system 10. Optical receiver system 10 includes an amplifier circuit 11, a compensation circuit 21 and a clock data recovery (CDR) and decision block 20.

Amplifier circuit 11 includes a transimpedance amplifier (TIA) 16 and a feedback resistor 15. Amplifier circuit 11 also includes a photo-detector 14 connected to VCC 13 as shown. Photo-detector 14 detects light signals 12. The resulting electrical signal produced by photo-detector 14 is amplified by TIA 16.

Compensation circuit 21 provides pole compensation outside of TIA 16. Since TIA 16 typically consists of three poles, three compensating stages can be used. However, compensation of major two poles (input related and output related), requiring only two compensating stages, is often enough to achieve a desired bandwidth of operation.

In the implementation of compensation circuit 21 shown in FIG. 1, three compensation stages are shown cascaded in series. A first compensation stage 25 receives control information from a variable control input 22. A second compensation stage 26 receives control information from a variable control input 23. A third compensation stage 27 receives control information from a variable control input 24. A signal quality monitoring feature that might be implemented in CDR and decision block 20 is used to control variable control input 22, variable control input 23 and variable control input 24.

Variable control input 22, variable control input 23 and variable control input 24 can be used for weight adaptation. This is useful, for example, because TIA 16 can have more complex AC responses by having more than 3 poles. For example, an additional pole or poles can result when the emitter parasitic capacitance of input TIA transistors generates a zero in TIA bandwidth performance creating somewhat unpredictable behavior of TIA 16. Weight adaptation performed with variable control input 22, variable control input 23 and variable control input 24 can also be used to compensate for conventional interface issues such as intersymbol interference (ISI) or skin effect that occur in additional circuitry of optical receiver system 10.

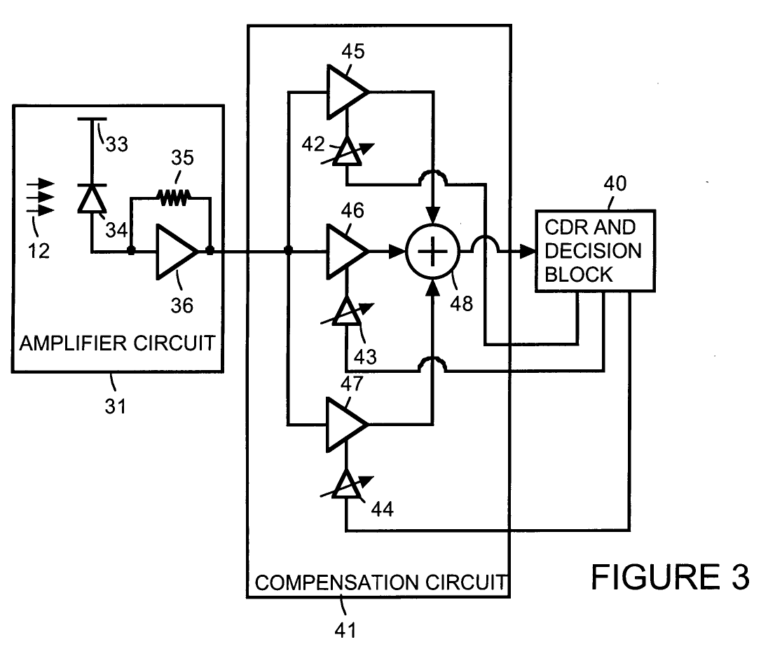

Arranging compensation stages in series results in less output parasitic of each stage. Alternatively, to make it easier to control weights, the compensation can be arranged in a parallel configuration, as shown in FIG. 3.

FIG. 3 is shows an alternative implementation of optical receiver system 10. Optical receiver system 10 in this embodiment is shown to include an amplifier circuit 31, a compensation circuit 41 and a clock data recovery (CDR) and decision block 40.

Amplifier circuit 31 includes a transimpedance amplifier (TIA) 36 and a feedback resistor 35. Amplifier circuit 31 also includes a photo-detector 34 connected to VCC 33 as shown. Photo-detector 34 detects light signals 12. The resulting electrical signal produced by photo-detector 34 is amplified by TIA 36.

Compensation circuit 41 provides pole compensation outside of TIA 36. Since TIA 36 typically consists of three poles, three compensating stages can be used. However, compensation of major two poles (input related and output related), requiring only two compensating stages, is often enough to achieve a desired bandwidth of operation.

In the implementation of compensation circuit 41 shown in FIG. 1, three compensation stages are shown arranged in a parallel configuration. A first compensation stage 45 receives control information from a variable control input 42. A second compensation stage 46 receives control information from a variable control input 43. A third compensation stage 47 receives control information from a variable control input 44. A summing circuit 48 is used to sum the outputs of compensation stage 45, compensation stage 46 and compensation stage 47.

An output signal quality monitoring feature, which can be implemented in CDR and decision block 40 is used to control variable control input 42, variable control input 43 and variable control input 44.

The use of a compensation circuit as illustrated in FIGS. 2 and 3 provides for maximum extension of receiver system bandwidth required for high-speed communication operation. It can also provide compensation for the relaxation oscillation and slow tail of light output from light-emitting device 92 within the optical transmitter system (shown in FIG. 1).

The technology used to implement the compensation circuit typically is the same used to implement the TIA based amplifier circuit, provided the bandwidth of each compensation stage covers maximum operational frequency required by equalization. Also, power consumption required for the compensation circuit is much less than power consumption resulting from an increase of TIA stage bandwidth. Additionally, the simple structure of the compensation stages leads to less time required for the development of the optical receiver system. Also, the compensation circuitry can be designed without affecting an existing TIA amplifier design, so compensation circuit can be added to an existing design of a TIA based amplifier circuit without affecting stability of the TIA based amplifier circuit. When the compensation circuit is used to compensate for transmitter light-emitting device characteristics, the compensation circuit improves the intrinsic relaxation oscillation of light-emitting diode without deteriorating rising or falling time of the signal.

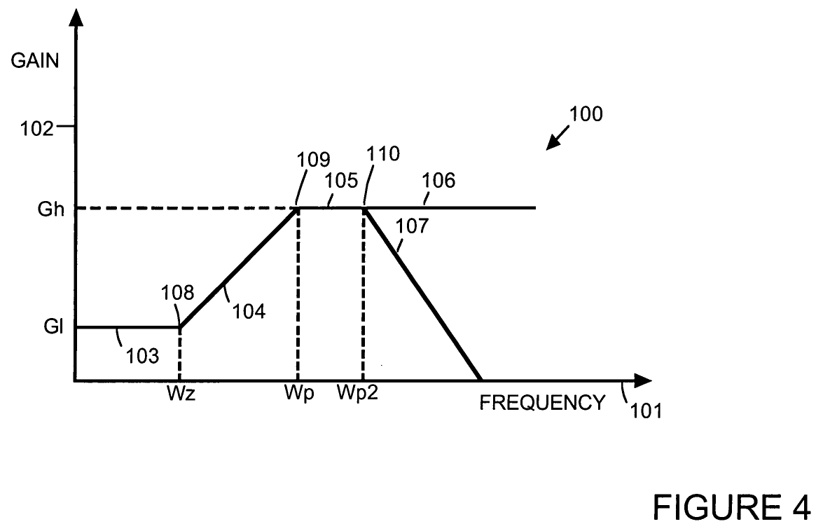

FIG. 4 is a diagram illustrating operation of a compensation stage. An axis 101 represents frequency. An axis 102 represents gain. A trace section 103 represents the compensation stage having a low gain (G1) at frequencies lower than a zero frequency (Wz) 108. A trace section 104 represents the compensation stage having a gain increasing from low gain (G1) to high gain (Gh) at frequencies between zero frequency (Wz) 108 and first pole frequency (Wp) 109. A trace section 105 represents the compensation stage having a high gain (Gh) at frequencies between first pole frequency (Wp) 109 and second pole frequency (Wp2) 110. A trace section 106 represents the compensation stage ideally having a high gain (Gh) at frequencies higher than second pole frequency (Wp2) 110. A trace section 107 represents the compensation stage in reality having a diminishing gain at frequencies higher than second pole frequency (Wp2) 110. The diminishing gain at frequencies higher than second pole frequency (Wp2) 110 is due to the intrinsic pole of the compensation stage itself. Nevertheless, the compensation stage can be designed so that the location of pole Wp2 is at a high enough frequency not to significantly affect the compensation of the TIA pole.

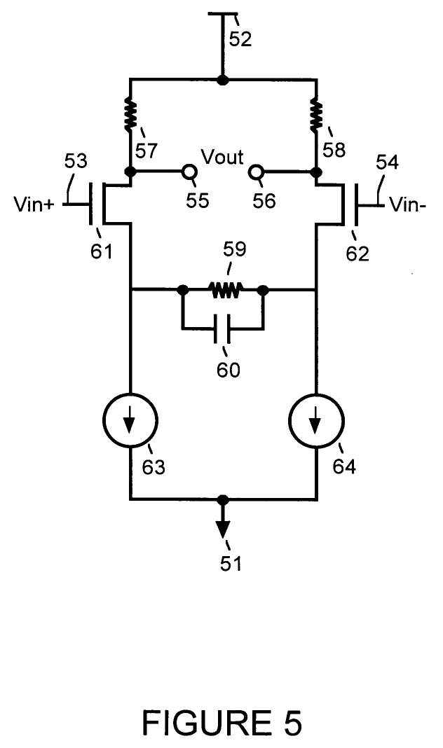

FIG. 5 shows an example implementation of a compensation stage implemented as a differential amplifier with pole compensation. The input for the compensation stage is implemented by a voltage-in (Vin)+53 and a Vin−54. The output for the compensation stage is implemented by voltage-out (Vout) leads 55 and 56. The compensation stage is implemented by a resistor 57, a resistor 58, a resistor 59, a capacitor 60, a field effect transistor (FET) 61, an FET 62, a current source 63 and a current source 64 connected to a VCC 52 and a ground 51, as shown. The gain of the compensation stage shown in FIG. 5 is adjusted, for example, by varying impedance of resistor 57 and resistor 58. The location of the pole for which the compensation stage of FIG. 5 compensates is adjusted, for example, by varying impedance of resistor 59.

In the compensation stage shown in FIG. 5, emitter RC degeneration differentiates the gains for DC and high frequency. Ideally, the zero frequency is set by the time constant of the RC circuit formed by 59 and capacitance 60; however, in practice the zero frequency is impacted by the effect of parasitic capacitance of the emitters of FET 61, FET 62, current source 63 and current source 64.

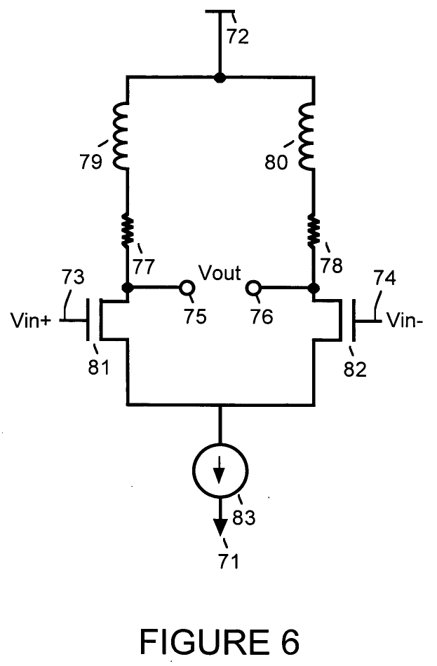

FIG. 6 shows another example implementation of a compensation stage implemented as a differential amplifier. The input for the compensation stage is implemented by a voltage-in (Vin)+73 and a Vin−74. The output for the compensation stage is implemented by voltage-out (Vout) leads 75 and 76. The compensation stage is implemented by a resistor 77, a resistor 78, an inductor 79, an inductor 80, an FET 81, an FET 82 and a current source 83 connected to a VCC 72 and a ground 71, as shown. The gain of the compensation stage shown in FIG. 6 is adjusted, for example, by varying impedance of resistor 77 and resistor 78. The location of the pole for which the compensation stage of FIG. 6 compensates is adjusted, for example, by varying inductances of inductor 79 and inductor 80.

In the compensation stage shown in FIG. 6, ideally, inductance through inductor 79 and inductor 80 set the zero frequency; however, in practice the zero frequency is impacted by the effect of parasitic capacitance of the emitters of FET 81, FET 82, and current source 83.

For example, when a TIA amplifier has a major pole contributed by parasitic of a photo detector at 5 GHz and output associated pole at approximately 9 GHz with a 27 GHz buffer stage, the overall bandwidth of the TIA stage is approximately 4.3 GHz, which is not enough to process an optical signal operating at 10 Gbps. A compensation circuit with two frequency compensation stages provides sufficient compensation to allow accurate detection of signals.

Frequency compensation for the light-emitting device on the transmitter side is accomplished by extracting the impulse response of the light-emitting device. Since the impulse response of the light-emitting device contains relative information, the impulse response is used as a reference for the compensation process. From this impulse response, the matching filter that puts out identical impulse response is created using currently available optimization tools. The typical impulse response of the light-emitting diode is composed of three poles. Two of the poles are conjugated poles and control the light-emitting devices intrinsic relaxation oscillation frequency by having a real part and an imaginary part. The third pole contributes to the adjustment of rising and falling time of transient response from the light-emitting device. A final compensation filter required for the actual compensation of light-emitting device characteristic is the inverse function of the matching filter implemented using the impulse response.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. An optical receiver system comprising:
an amplifier circuit, the amplifier circuit including:
a light detector,
a transimpedance amplifier, and
an output on which is placed an amplified signal; and,
a pole compensation circuit connected to the output of the amplifier circuit, the pole compensation circuit comprising:
a first pole compensation stage that performs pole compensation on the amplified signal for a first pole.

2. An optical receiver system as in claim 1 wherein the compensation circuit additionally comprises:
a second pole compensation stage connected in series with the first pole compensation stage.

3. An optical receiver system as in claim 1 wherein the compensation circuit additionally comprises a second pole compensation stage and a third pole compensation stage connected in series along with the first pole compensation stage.

4. An optical receiver system as in claim 1 wherein the compensation circuit additionally comprises:
a second pole compensation stage connected in parallel with the first pole compensation stage.

5. An optical receiver system as in claim 1 wherein the compensation circuit additionally comprises a second pole compensation stage and a third pole compensation stage connected in parallel along with the first pole compensation stage.

6. An optical receiver system as in claim 1 wherein the first pole compensation stage comprises an RC circuit used to control location of a zero frequency for the first pole compensation stage.

7. An optical receiver system as in claim 1 wherein the first pole compensation stage comprises inductance used to control location of a zero frequency for the first pole compensation stage.

8. A method for receiving an optical signal comprising:
detecting the optical signal with a light detector to produce an electrical signal;
amplifying the electrical signal with a transimpedance amplifier to produce an amplified signal; and,
performing pole compensation of the amplified signal to produce a compensated signal.

9. A method as in claim 8 wherein pole compensation of the amplified signal is performed by a plurality of pole compensation stages connected in series.

10. A method as in claim 8 wherein pole compensation of the amplified signal is performed by a plurality of pole compensation stages connected in parallel.

11. A method as in claim 8 wherein pole compensation of the amplified signal is performed using an RC circuit used to control location of a zero frequency.

12. A method as in claim 8 wherein pole compensation of the amplified signal is performed using inductance to control location of a zero frequency.

13. An optical receiver system comprising:
a light detection means for detecting an optical signal and producing an electrical signal;
first amplification means for performing transimpedance amplification of the electrical signal to produce an amplified signal; and,
compensation means for performing pole compensation on the amplified signal to produce a compensated signal.

14. An optical receiver system as in claim 13 wherein the compensation means comprises:
a plurality of pole compensation stages connected in series.

15. An optical receiver system as in claim 14 wherein each pole compensation stage comprises an RC circuit used to control location of a zero frequency for the pole compensation stage.

16. An optical receiver system as in claim 14 wherein each pole compensation stage comprises inductance used to control location of a zero frequency for the pole compensation stage.

17. An optical receiver system as in claim 13 wherein the compensation means comprises a plurality of pole compensation stages connected in parallel.

18. An optical receiver system as in claim 17 wherein each pole compensation stage comprises an RC circuit used to control location of a zero frequency for the pole compensation stage.

19. An optical receiver system as in claim 17 wherein each pole compensation stage comprises inductance used to control location of a zero frequency for the pole compensation stage.
